(19) United States
(12) Patent Application Publication
(10) Pub. No.: US 2009/0019348 A1
(43) Pub. Date: Jan. 15, 2009

(54) Fractal Grid Hierarchical Presentation Of Information

(76) Inventor: Rodney Kuhn Haffnerson King, Fresno, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/931,539

(22) Filed: Oct. 31, 2007

Related U.S. Application Data
(60) Provisional application No. 60/959,526, filed on Jul. 13, 2007.

(51) Int. Cl. G06F 3/048; G06F 17/21

(52) U.S. Cl. 715/205; 715/855; 715/780; 715/833; 715/769

(57) ABSTRACT

Information is displayed according to a fractal grid hierarchy that consists of multiple levels of resolution. Each level of a fractal grid hierarchy displays one or more cells in a nine-cell grid fashion. For each level after the first level, the level comprises a grid of nine cells for each cell of the previous level. This pattern is repeated for successive levels; the term fractal refers to this characteristic of a fractal grid hierarchy.

### RELATED APPLICATIONS

The present application claims priority to U.S. Provisional Application No. 60/959,526, entitled Fractal Grid Hierarchical Presentation of Information, filed on Jul. 13, 2007 by Rodney King, the entire disclosure of which is incorporated herein by reference.

### FIELD OF THE INVENTION

The present invention relates to graphical user interfaces for displaying items of related information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a fractal grid hierarchy showing level 0 of a fractal grid hierarchy according to an embodiment of the present invention.

FIG. 2 depicts a fractal grid hierarchy showing level 1 of a fractal grid hierarchy according to an embodiment of the present invention.

FIG. 3 depicts a fractal grid hierarchy showing level 2 of a fractal grid hierarchy according to an embodiment of the present invention.

FIG. 4 depicts a fractal grid hierarchy showing level 0 of a fractal grid hierarchy according to an embodiment of the present invention.

FIG. 5 depicts a fractal grid hierarchy showing level 1 of a fractal grid hierarchy according to an embodiment of the present invention.

FIG. 6 depicts a fractal grid hierarchy showing level 2 of a fractal grid hierarchy according to an embodiment of the present invention.

FIG. 7 depicts a fractal grid hierarchy showing level 1 of a fractal grid hierarchy according to an embodiment of the present invention.

FIG. 8 depicts a fractal grid hierarchy showing level 2 of a fractal grid hierarchy according to an embodiment of the present invention.

FIG. 9 depicts level 0 of a bi-coordinate grid hierarchy, according to an embodiment of the present invention.

FIG. 10 depicts level 1 of a bi-coordinate grid hierarchy, according to an embodiment of the present invention.

FIG. 11 depicts level 2 of a bi-coordinate grid hierarchy, according to an embodiment of the present invention.

FIG. 12 depicts a user interface that includes a menu control that is expanded within a fractal grid hierarchy according to an embodiment of the present invention.

FIG. 13 depicts a user interface with a menu control expanded within a grid control according to an embodiment of the present invention.

FIG. 14 depicts a user interface with a menu control expanded within two levels of a grid hierarchy, according to an embodiment of the present invention.

FIGS. 15A, 15B, 15C and 15D depict a user interface showing how a peripheral cell is expanded within a grid, according to an embodiment of the present invention.

FIGS. 16 and 17 depict a fractal grid hierarchy based on the penta-grid.

FIG. 18 is a block diagram depicting a computer system which may be used in an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein are approaches for organizing the display of information. Information is displayed according to a fractal grid hierarchy that consists of multiple levels of resolution. Each level of a fractal grid hierarchy displays one or more cells. For each level after the first level, the level comprises a grid formed according to the same fractal pattern applied to the previous level. In an embodiment, each cell from the previous level is divided and/or organized according to a fractal pattern. Each cell at the previous level is divided or organized according to the fractal pattern. The term fractal refers to this characteristic of a fractal grid hierarchy.

According to embodiment, a level is formed by dividing a cell in the previous level into a nine cell grid. This pattern is repeated for successive levels. Other grids formed according to other patterns are also described. The present invention is not limited to a grid with cells of uniform size and/or shape.

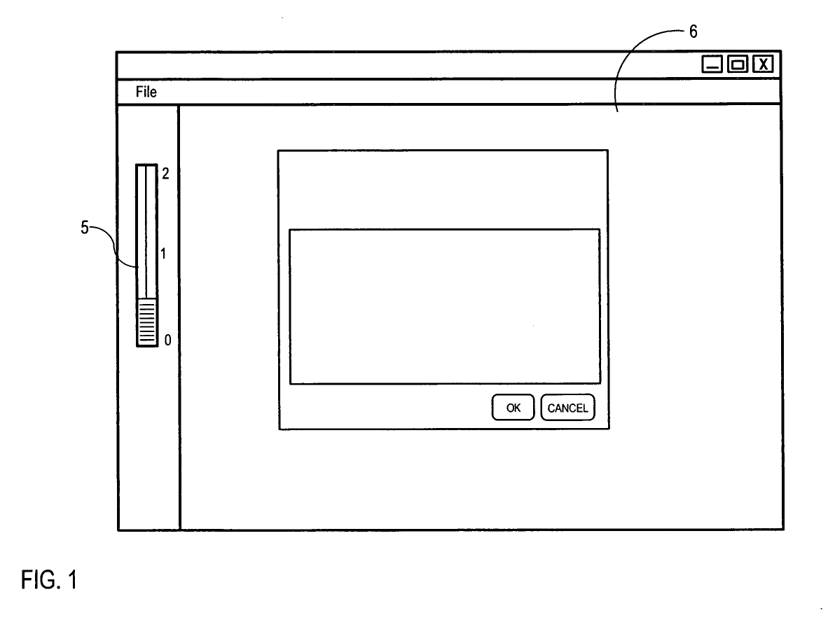

FIGS. 1, 2, and 3 display levels 0, 1, and 2 of fractal grid hierarchy 1, each of the levels corresponding to a respective level of a fractal grid hierarchy according to an embodiment of the present invention.

FIG. 1 shows level 0 of the fractal grid hierarchy. Level 0 of a fractal grid hierarchy has one cell referred to as the root cell of the fractal grid hierarchy, which is represented here by dialogue box 6. Dialogue box 6 may be used to display or enter information associated with the root cell.

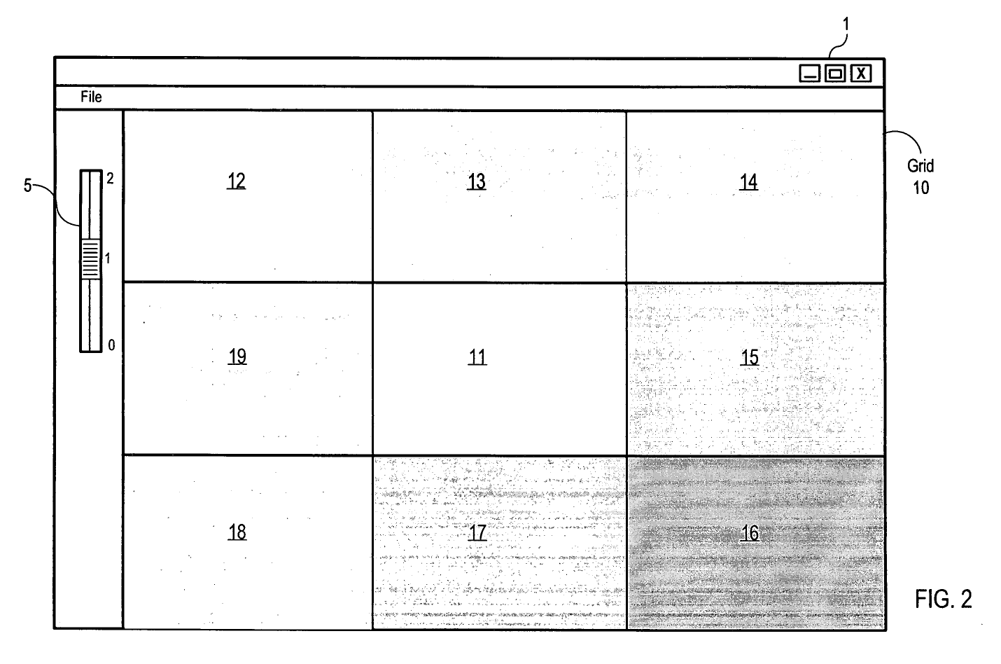

FIG. 2 depicts a display of a fractal grid hierarchy 1, a user interface used for displaying information organized as a fractal grid hierarchy. Fractal grid hierarchy 1 includes a grid control 10. The term control is used herein to a graphical user control. Displayed within grid control 10 are nine cell controls 11, 12, 13, 14, 15, 16, 17, 18, and 19. Each of these cells is demarcated by a border and may have a different color. This display of the fractal grid hierarchy corresponds to level 1 of the fractal grid hierarchy.

A graphical user control or control is a graphic displayed on a video display (e.g. CRT, LCD) that may be manipulated via an input device to provide input to a processor device, such as a computer. Examples of such input devices include a mouse and or key board, a touch screen, or voice interface. Examples of user graphical controls include menus, list boxes, action buttons, sliders and radio buttons, labels, text hyperlinks, windows, and frames. A control may comprise other controls. For convenience of expression, when referring to a cell or grid control, the terms cell or grid control may be used.

The center cell in a grid of cells is referred to herein as the center cell, while other cells in the grid are referred to as peripheral cells. Accordingly, cell 11 is a center cell and cells 12-19 are peripheral cells. Each of the peripheral cells occupies a position with respect to the center cell. Cell 12 is in the top-left position, cell 13 the top, cell 14 the top-right, cell 15 right, cell 16 right-bottom, cell 17 the bottom, cell 18 bottom-left and cell 19 left.

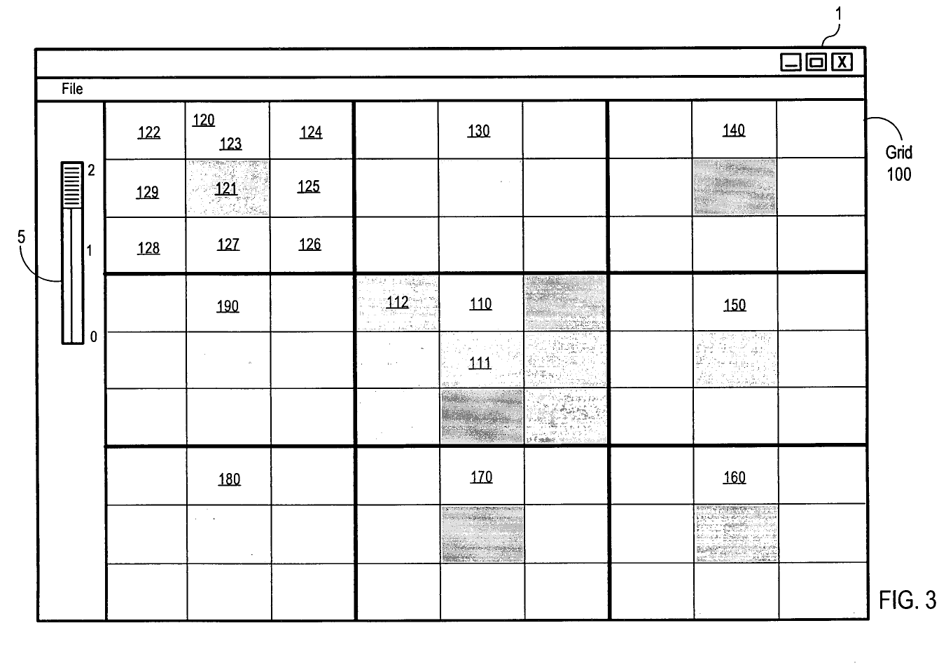

Slide control 5 may be manipulated to cause a computer to display another level of the fractal grid hierarchy. FIG. 3 shows the display of the fractal grid hierarchy at level 2. Like level 1, a grid with nine cell controls is displayed. However, each cell is further divided into nine cells to form a nine cell grid or grid-cell.

Referring to FIG. 3, grid control 100 consists of nine main cells 110, 120, 130, 140, 150, 160, 170, 180, and 190. Each of main nine cells 110, 120, 130, 140, 150, 160, 170, 180, and 190 is a grid-cell consisting of nine cells.

For example, cell 120 comprises cell controls 121, 122, 123, 124, 125, 126, 127, 128, and 129. Note these cells are referred to herein as base cells because they are not grid-cells. The cells are also referred to herein as secondary cells because the cells are the second and finer scale of grid cells displayed within grid control 100.

A grid not within the cell of another grid is the main grid. Grid controls 10 and 100 are thus main grids. The nine rougher scale cells into which a main grid is divided are referred to herein as main cells. In FIG. 2, the main cells are cells 11-19 and in FIG. 3 the main cells are cells 110, 120, 130, 140, 150, 160, 170, 180, and 190.

Note that each level of a fractal grid hierarchy is based on a pattern of dividing each base cell in a previous level into a grid-cell of nine cells. Level 1 represents a division of a root cell into a nine cell main grid composed of only main cells, and level 2 represents a division of each base cell in level 1 into a nine cell grid-cell. The pattern can continue to the lower levels. At level 3, the base cells of level 2 are divided into nine cell grid-cells consisting of tertiary cells.

### Vertical Hierarchy

A fractal grid hierarchy is used to display a collection of information nodes. Each node has node content, some or all of which may be displayed in one or more base cells. According to an embodiment, the collection of information nodes is vertical hierarchy.

In a vertical hierarchy, the collection of information nodes is an information tree hierarchy in which each node has a hierarchical position in a tree hierarchy that has one root node. A vertical hierarchy is composed of nodes at multiple levels. The nodes at each level are each linked according to some relationship to one or more nodes at an adjacent level. Each node at a level below the top level is a child node of one or more of the parent nodes at the level above. Nodes at the same level are sibling nodes. Each child node may have only one parent node, and a parent node may have multiple child nodes.

A vertical information hierarchy may be used to represent categories. The categories in which information is organized are themselves typically organized relative to each other in some form of hierarchy. For example, an individual animal belongs to a species, the species belongs to a genus, the genus belongs to a family, the family belongs to an order, and the order belongs to a class.

### Displaying Vertical Information Hierarchy Within a Fractal Grid Hierarchy

A version of a fractal grid hierarchy, referred to herein as a vertical grid hierarchy, is useful for organizing and presenting a vertical information hierarchy. In a vertical grid hierarchy, at level 0, only the root node of the vertical information hierarchy is displayed, and it is displayed in the root cell. At level 1 of the vertical grid hierarchy, the root node is expanded within the main grid, that is, the root node and its child nodes are displayed within the main grid. The root node is displayed within the main center cell of the main grid, children nodes of the root node are displayed in the main peripheral cells. At level 2, each main cell of level 1 becomes a grid-cell. The root node and level 1 child nodes are all displayed within the main center grid-cell; the root node is displayed within the center cell and each child node of the root node is displayed within a peripheral cell of the main center cell. Each level 1 child node of the root node is expanded within each main peripheral cell. That is a level 1 child node is the center cell of a peripheral main grid-cell and the children nodes of that level 1 child node are displayed in a peripheral cell of that main grid-cell. This pattern may be repeated at lower levels.

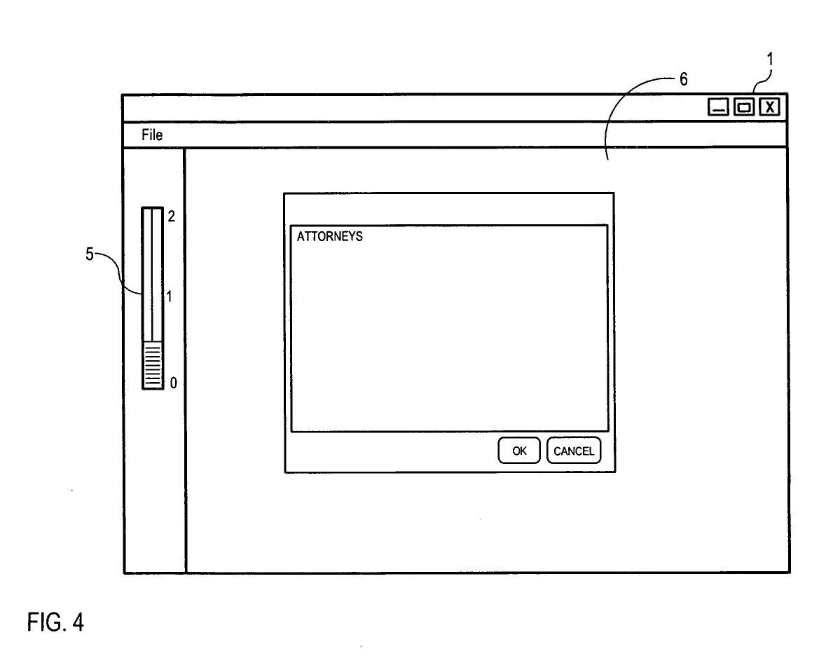

To illustrate a vertical grid hierarchy, the illustrative fractal grid hierarchy depicted in FIGS. 4-6 is used to display vertical information hierarchy about attorneys, referred to herein as the attorney hierarchy. FIGS. 4-6 depicts use of an illustrative vertical grid hierarchy for displaying an attorney hierarchy.

Referring to FIG. 4, it depicts dialogue box 6. The dialogue box displays content of a root node of the hierarchy, which is the word ATTORNEYS.

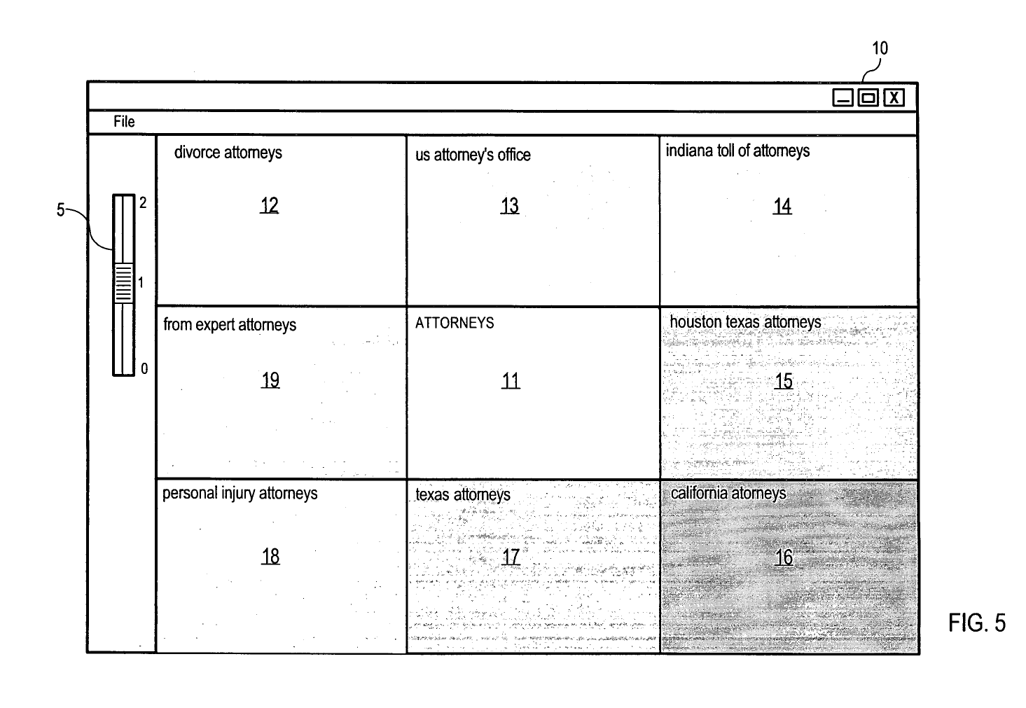

FIG. 5 depicts level 1 of the vertical grid hierarchy. The center cell 11 of grid 10 displays content of the root node. The peripheral cells 12-19 display content of child nodes of the root node. Each node represents a subcategory of attorney information. Cell 12 represents the node and subcategory of information “divorce attorneys”, cell 13 represents the node and subcategory of information on “US attorney's office”, cell 14 represents the node and subcategory of information on “Indiana roll of attorneys”, cell 15 represents the node and subcategory of information on “Houston, Texas attorneys”, cell 16 represents the node and subcategory of information on “California attorneys”, cell 17 represents the node and subcategory of information on “Texas attorneys”, cell 18 represents the node and subcategory of information on “personal injury attorneys”, and cell 19 represents the node and subcategory of information of “from expert attorneys.”

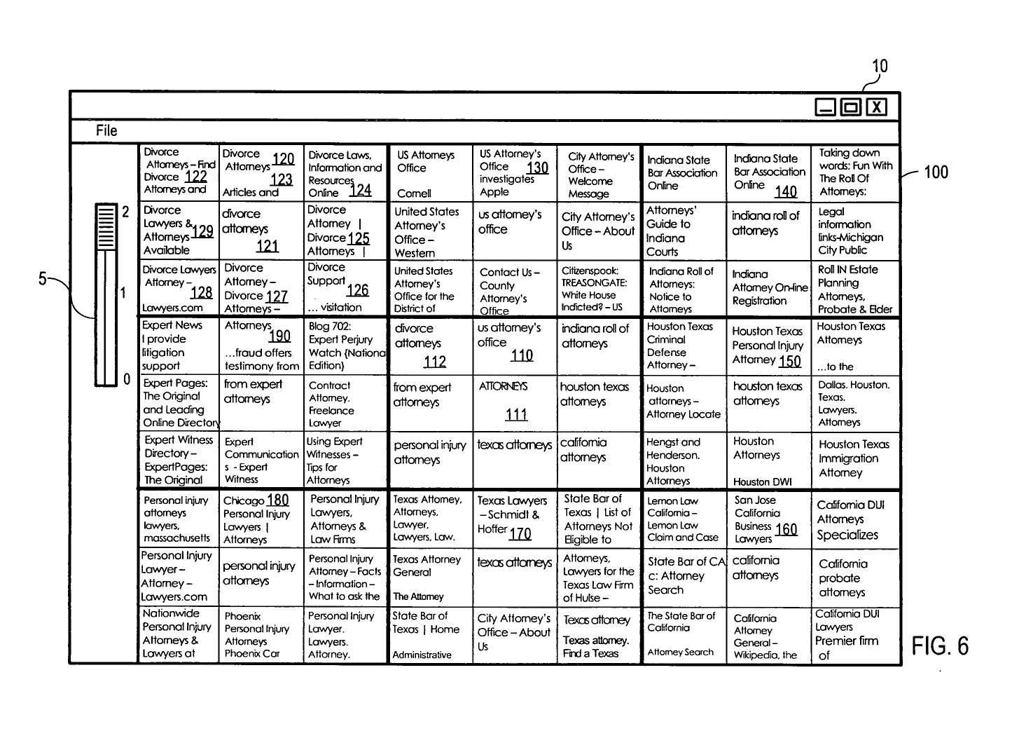

For a level beyond level 1 in the vertical grid hierarchy, information within the main grid of the previous level is displayed within the center cell of the main grid. This pattern is illustrated by FIG. 6, which depicts level two of the vertical hierarchical graph.

Referring to FIG. 6, the main grid 10 of the previous level 1 is displayed as the center grid-cell 110 of the main grid 100 of the current level 2. Each peripheral cell of center grid-cell 110 is “expanded” within a main peripheral cell of level 2. Specifically, the node of each peripheral cell of center grid-cell 110 and the corresponding child nodes are displayed within a main peripheral cell of the current main grid. The node of a peripheral cell of the center grid-cell 110 is displayed within center cell of a main peripheral cell; the main peripheral cell contains secondary peripheral cells each of which represent a child node of node depicted in the respective secondary center cell.

According to the embodiment, coloring is used to indicate the grid-cell in which a peripheral cell is expanded. For example, the color of the left-top peripheral cell 112 is identical to the corresponding center cell 121 of the peripheral grid-cell 120 in which the left-top peripheral cell 112 is expanded.

As a result, three levels of the vertical node hierarchy are displayed at the level 2 of the vertical grid hierarchy. The main center grid-cell 110 displays the first and second level. Each of the main peripheral grid-cells displays a parent node in a second level in a center cell and the child nodes in third level. For example, the root node of the attorney hierarchy is displayed within center cell 111; a child node (i.e. “divorce attorneys”) of the root node is displayed within peripheral cell 112 and center secondary cell 121. This child node is a parent node to other child nodes at the third level, all of which are displayed in peripheral cells of center secondary cell 121.

### Content of Nodes

The present invention is not limited to any type of node content to provide information of any type and form. The content of a node includes, without limitation, text, graphics, audio-visual data, some or none of which may be displayed or rendered within a cell. The information may be, without limitation, advertising or educational. A cell may contain graphic controls that facilitate viewing part of the content, such as a scrollable display with scroll bars for scrolling.

In an embodiment, the content of a node may include a resource on the Web and Internet and a link for accessing the source. For example, cell 126 may display a link to a web page for Divorce Support.

### Horizontal Hierarchy

A fractal grid hierarchy is also useful for displaying a collection of information nodes that are related as a flat hierarchy. In a flat hierarchy, there are two levels: the first level has one root node, the second level has child nodes that are children of the root node.

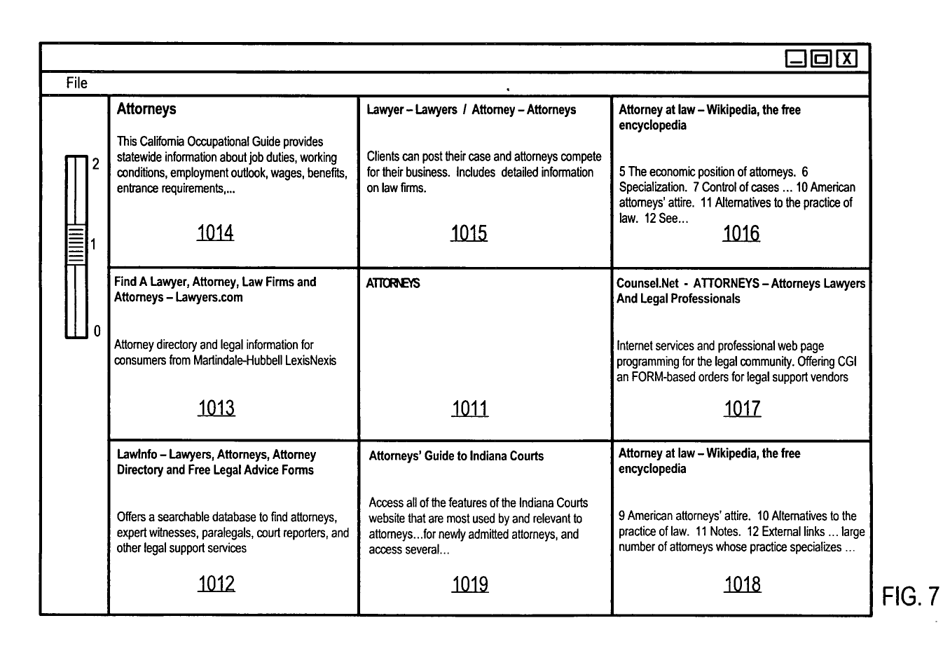

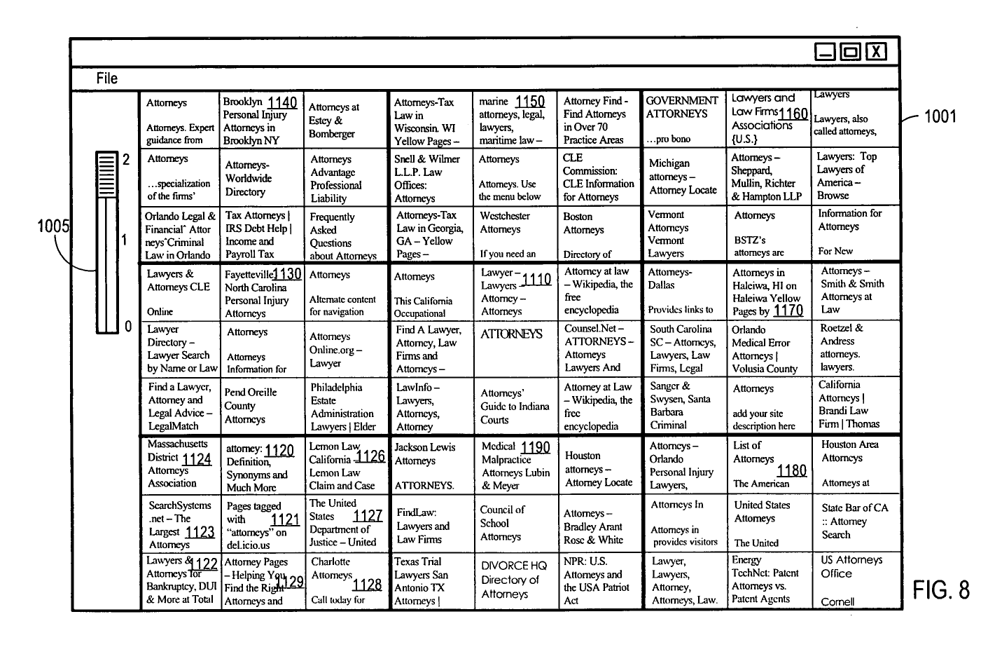

One particularly useful example of a flat hierarchy of information nodes that may be displayed in a fractal grid hierarchy are the search results of a query generated by a search engine on the Web. The query (i.e. query text) is the content of the root node and the query results are the children nodes of the root. FIGS. 7-8 depict a fractal grid hierarchy for displaying query results as a flat hierarchy.

FIG. 7 depicts level 1 of a flat grid hierarchy used to display a flat information hierarchy of information nodes representing the ranked search results of the query string “ATTORNEYS”. The first level displays a first set of ranked results. The first set may correspond to a first page of 9 results returned by a conventional search engine. Center cell 1011 displays the first search result, while periphery cells 1012 (2^{nd} ranked), 1013 (3^{rd}), 1014 (4^{th}), 1015 (5^{th}), 1016 (6^{th}), 1017 (7^{th}), 1018 (8^{th}), and 1019 (9^{th}) display in order the 2^{nd} through 9^{th} results.

Each grid displays summary information about the resource on the Web matching the query, including a summary of matching text and a URL. Within a particular base cell, a link may be clicked to access a page.

FIG. 8 displays an additional 8 sets of results. The 8 sets may correspond to eight pages of results returned by the search engine. The first set of results displayed at level 1 are displayed within the main center cell 1110 of grid 1001. Each of the additional 8 sets is displayed and expanded within a main periphery cell of grid 1001. For example, the next and second set of results containing the next highest after the first set are displayed within main periphery cell 1120. Of the second set, the first ranked result is displayed within cell 1121 (1^{st}), then the remaining ranked results are displayed in ranked order in cells 1122 (2^{nd} ranked), 1123 (3^{rd}), 1124 (4^{th}), 1125 (5^{th}), 1126 (6^{th}), 1127 (7^{th}), 1128 (8^{th}), and 1129 (9^{th}), respectively. The remaining additional sets of results are displayed and expanded, in order, in main periphery cells 1130, 1140, 1150, 1160, 1170, 1180, and 1190, respectively.

### Other Highlights

The fractal grid hierarchies described herein have various important features. In an embodiment, fractal grid interface comprises a slider control which may be manipulated to switch between display of different levels of a fractal grid hierarchy.

For example, referring to FIG. 7, slider control 1005 can be set between positions 0, 1, or 2, as indicated by labels of the slider control. Each corresponds to a level of a fractal grid hierarchy. Slider control 1005 is set to position 1, to indicate the level of a fractal grid hierarchy being displayed. Slider control 1005 may be manipulated to position 2 to cause display of level 2, as depicted in FIG. 8.

Another important feature is that only part of the collection of information nodes need be displayed within a fractal grid interface. However, further information may be accessed by manipulating various controls. This feature has several aspects. First only some but not all information nodes in a collection are displayed. For example, when the slider control 5 is set to position 1, level 0 and level 1 nodes of vertical information hierarchy are displayed, as shown in FIG. 5. The slider control can be set to position 2 to display in level 2 in addition to level 0 and level 1 as depicted in FIG. 6.

Another aspect is that only a portion of content of an information node need be displayed within a cell. The cell, being a user graphical control, may be manipulated to display more of the information node's content. For example, a cell may comprise a scrollable display with scroll bars that may be manipulated to scroll the display of an information node. In another example, the cell may be clicked to invoke a dialogue box to view further information about a node, or even to enter data for an information node. In yet another example, one based on query results depicted in FIG. 8, cell 126 displays a node having content that includes a web page for Divorce Support. The information displayed includes a link. The link may be clicked to access the Web page. When clicked, a browser window is opened and the web page is displayed. Alternatively, fractal grid interface may be displayed in a browser as a page, which is replaced when the link is clicked to access the web page.

### Bi-Coordinate Information Hierarchy

A fractal grid hierarchy may be used to a represent collection of information nodes referred to as a bi-coordinate hierarchy. In a bi-coordinate hierarchy, nodes are not only associated with a level but with a subarea of a two coordinate system (e.g. x, y coordinates). Each node is displayed beginning at a corresponding level of a fractal grid hierarchy.

For a particular level of a fractal grid hierarchy, each cell within the respective grid corresponds to an area or subarea of a two coordinate system based on the cell's respective location within the grid. At a particular level, a node is displayed within the cell associated with the node's area.

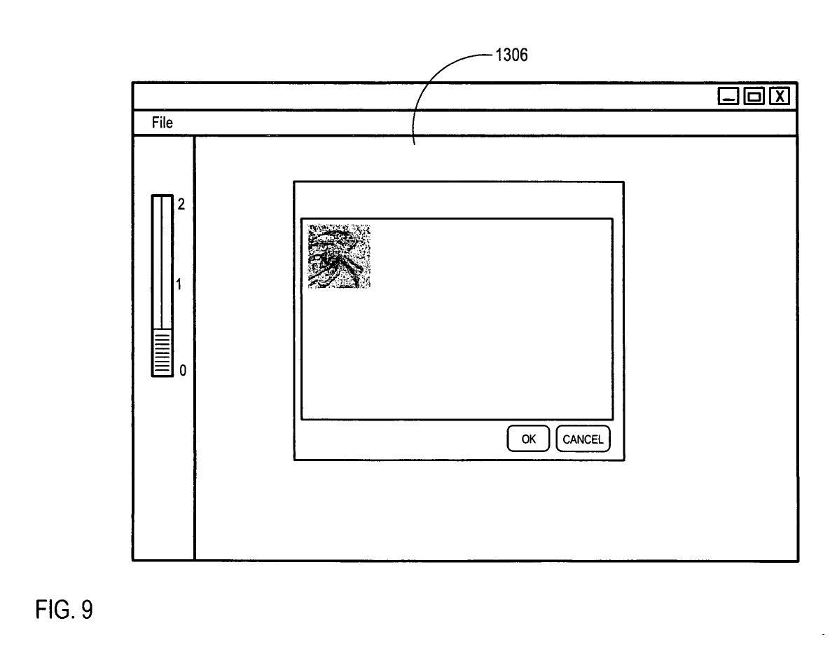

A fractal grid hierarchy that represents a bi-coordinate grid hierarchy is referred to herein as a bi-coordinate grid hierarchy. FIGS. 9, 10, and 11 represent an example of bi-coordinate information hierarchy that may be based on the coordinates of a Delight-Pain Map, where the vertical coordinate represents the painful measure of taxation and the horizontal coordinate represents the delightful measure of income per capita. The more taxation, the greater the pain; the more income per capita, the greater the delight. A node may represent a subarea and/or a state within a particular subarea. Each level of the grid hierarchy presents greater detail about the Delight-Pain Map and correlation between states and to sub areas.

FIG. 9 depicts level 0 of bi-coordinate grid hierarchy, which includes dialogue box 1306. The dialogue box displays content of the single node at level 0, and represents the complete area of the Delight-Pain Map. The content of this node is a squid (i.e. graphic of squid), which is an animal representing medium taxation and income, i.e. medium pain and medium delight.

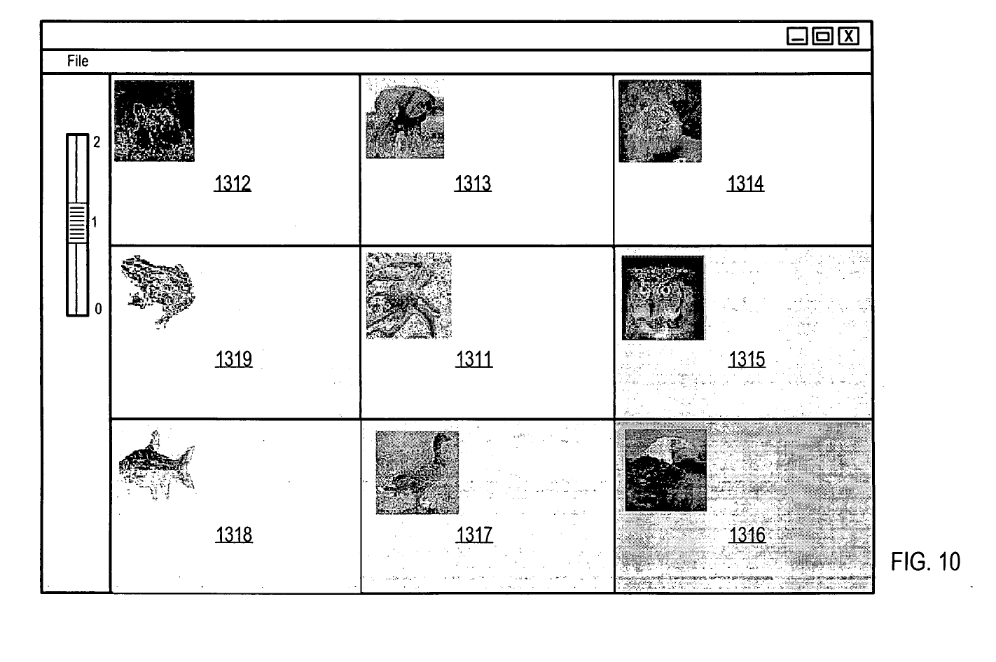

FIG. 10 depicts level 1 of the vertical grid hierarchy. Each cell corresponds to a subarea of the coordinate system. The center cell 1311 corresponds to medium taxation and medium income, i.e. which corresponds to the node whose content is a squid. The squid is accordingly displayed within center cell 1311.

The other cells are associated with other nodes that correspond to the cell's subarea of the coordinate system, and with nodes associated within the subarea. The content of the other nodes include an animal graphic representing the corresponding degree of taxation and income. Cell 1312 corresponds to high taxation and low income, and displays a tortoise. Cell 1313 is associated with high taxation and medium income, and displays an elephant. Cell 1314 is associated with high taxation and high income, and displays a lion. Cell 1315 is associated with medium taxation and high income, and displays an owl. Cell 1316 is associated with low taxation and high income, and displays a bald eagle. Cell 1317 is associated with low taxation and medium income, and displays a goose. Cell 1318 is associated with low taxation and low income, and displays a fish. Cell 1319 is associated with medium taxation and low income, and displays a toad.

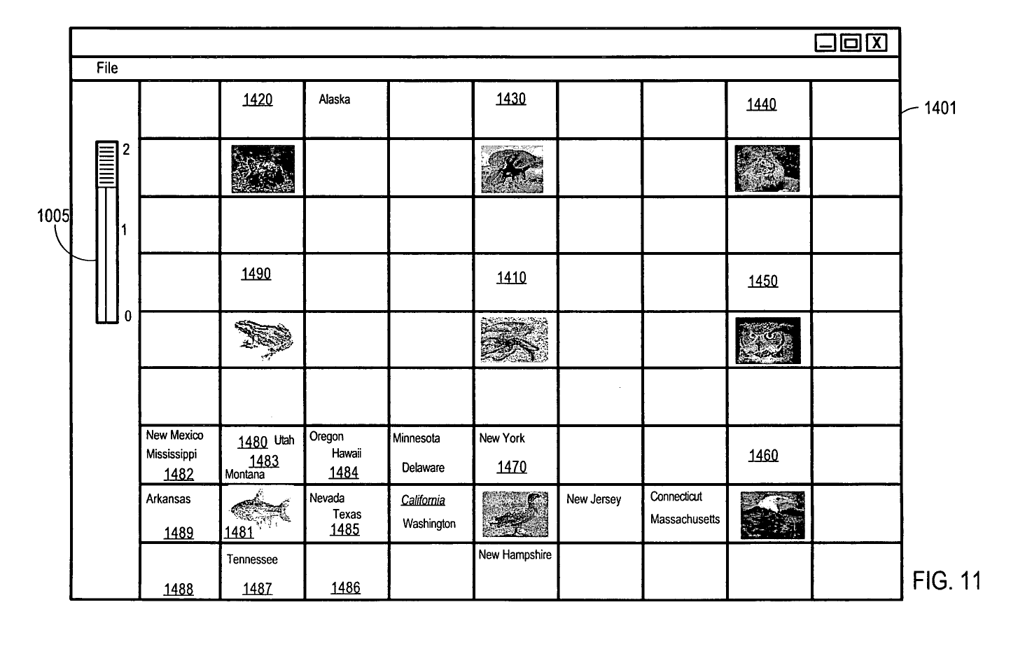

FIG. 11 displays the next level of the bi-coordinate grid hierarchy. Referring to FIG. 11, each cell in the previous level 1 is displayed and expanded in the center cell of a corresponding main cell of grid 1401; more nodes and more detail is shown about the subarea of the cell in the previous level; states that fall within the subarea are displayed therein.

For example, the fish of cell 1318 is displayed within the center cell of main cell 1480. The nodes at the second level of the bi-coordinate node hierarchy that fall within the subarea associated with cell 1318 or 1480 are displayed within a particular base cell of cell 1480. These nodes are associated with states, and thus the display serves to correlate states with a level of taxation and income. Accordingly, states associated with low taxation and low income are displayed within a base cell of cell 1480. New Mexico and Mississippi are displayed in base cell 1482, Utah and Montana are displayed with base cell 1483, Oregon and Hawaii are displayed within base cell 1484, Nevada and Texas are displayed within base cell 1485, Tennessee is displayed within base cell 1487, and Arkansas is displayed within base cell 1489.

Note that the nodes are displayed in a base cell that is associated with the subarea of the nodes. New Mexico and Mississippi have higher taxation but lower income than Nevada or Texas.

Similarly, cell 1312 is expanded within main cell 1420; cell 1313 is expanded within cell 1430; cell 1314 is expanded within main cell 1440; cell 1315 is expanded within main cell 1450; cell 1316 is expanded within main cell 1460; cell 1317 is expanded within main cell 1470; cell 1319 is expanded within main cell 1490.

### Grid Menus

In an embodiment, a certain level of a fractal grid hierarchy is displayed in response to a user clicking a control or moving a cursor over a control, such as a menu or tab control. The next lower level of the fractal grid hierarchy is displayed by clicking or otherwise manipulating a cell.

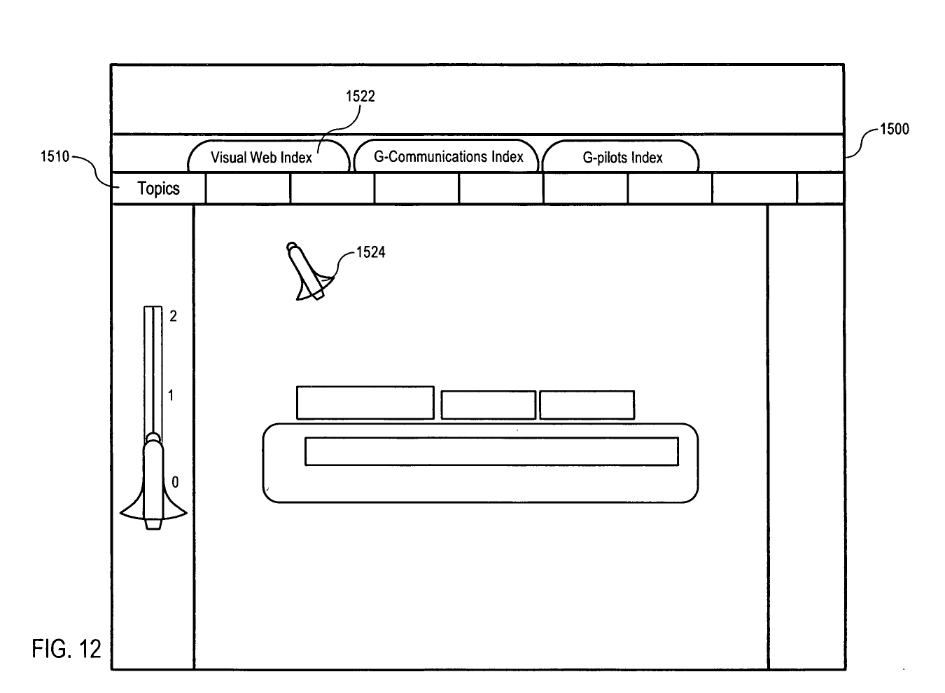

This approach is useful for displaying menu's in GUIs. FIGS. 12-14 depict such an embodiment.

Referring to FIG. 12, depicted therein is GUI 1500. GUI 1500 includes menu control 1510 and tab control 1522. Mouse cursor 1524 is a control that represents the current position of a mouse input device.

Menu control 1510 and tab control 1522 represent level 0 of a fractal grid hierarchy. The next level of any of the fractal grid hierarchy may be displayed by moving cursor pointer 1524 over one of these controls.

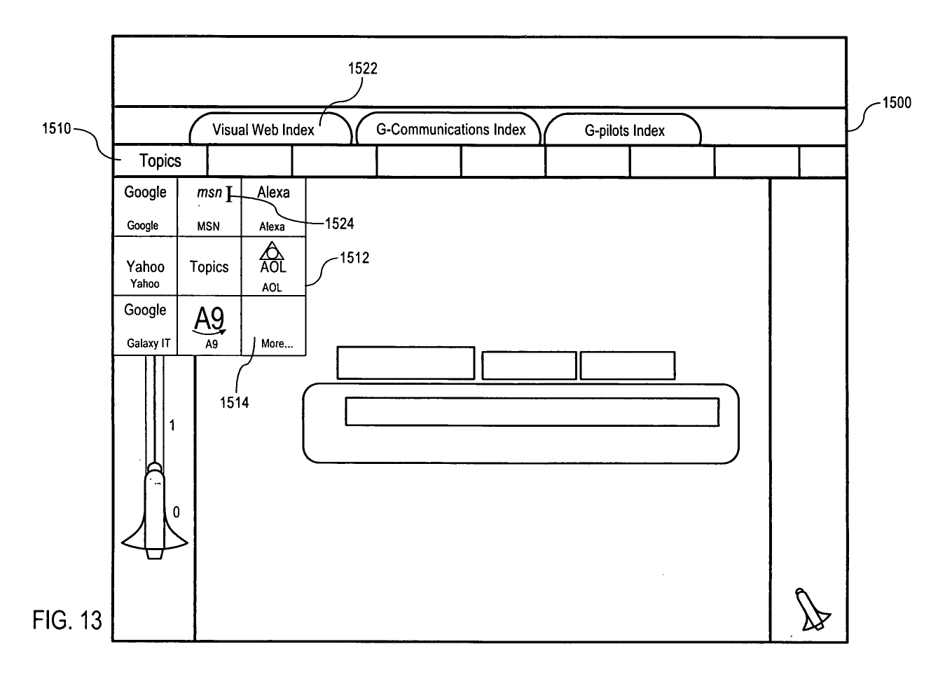

FIG. 13 shows the fractal grid hierarchy that is displayed when cursor pointer 1524 is moved over menu control 1510. Menu control 1510 is expanded as expanded menu control 1512, showing level 1 of the fractal grid hierarchy. The menu options of menu control 1512 thus comprise the nodes displayed at level 1 of the fractal grid hierarchy. (Note that as depicted in FIG. 13, mouse cursor 1524 has been further moved to a position over expanded menu control 1512). One cell of expanded menu control 1512, cell 1514 (displaying content “More . . . ”), maybe manipulated to display the next level of the fractal grid hierarchy.

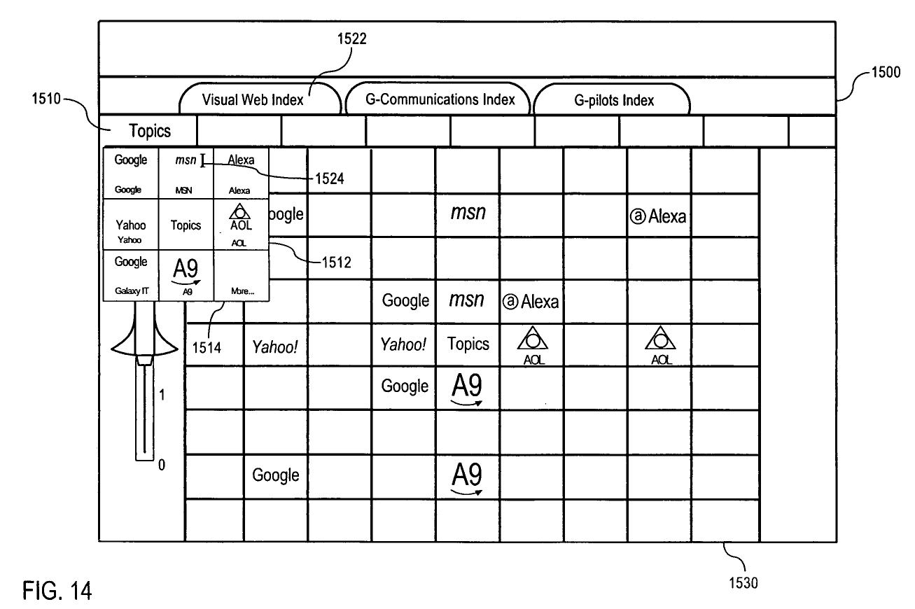

Referring to FIG. 14, in response to clicking cell 1514, the next level is displayed within grid 1530. Note that expanded menu control 1512 is displayed within the main center grid cell of grid 1530. Each of the peripheral cells of expanded menu control 1512 is expanded within a peripheral main grid cell of grid 1530.

### Drag and Drop Expansion

According to an embodiment, a collection of information nodes or a node within a collection may be expanded within fractal grid hierarchy by dragging and dropping a control representing the collection or the node into a portion of a fractal grid hierarchy control.

For example, multiple collections of nodes may each be represented by an icon. The icons are displayed on a desktop displayed by a computer. A separate grid control of an empty fractal grid hierarchy is displayed on the desktop; nine empty cells of a 3×3 grid are displayed. In response to dragging one of the icons into the grid control, the second level of the respective collection of information nodes is displayed within the fractal grid hierarchy.

Next, user input is received specifying to display the next level of the fractal grid hierarchy. In response, a 9×9 cell grid is displayed to display the third level of the fractal grid hierarchy and collection of information nodes.

Another icon representing another collection of information nodes is then dragged into the fractal grid hierarchy. In response, level 3 of that collection of information nodes is displayed in lieu of the collection that was being displayed before the drag and drop operation.

### Expanding a Single Node

In an embodiment, a peripheral cell within a displayed grid may be selected for expansion within the display, overwriting the display of the nodes with the expanded display. The selected peripheral cell is expanded by displaying the selected node, i.e. the node that was being displayed in the selected cell. Nodes in the next level that are associated with the selected node are displayed in the peripheral cells of the grid.

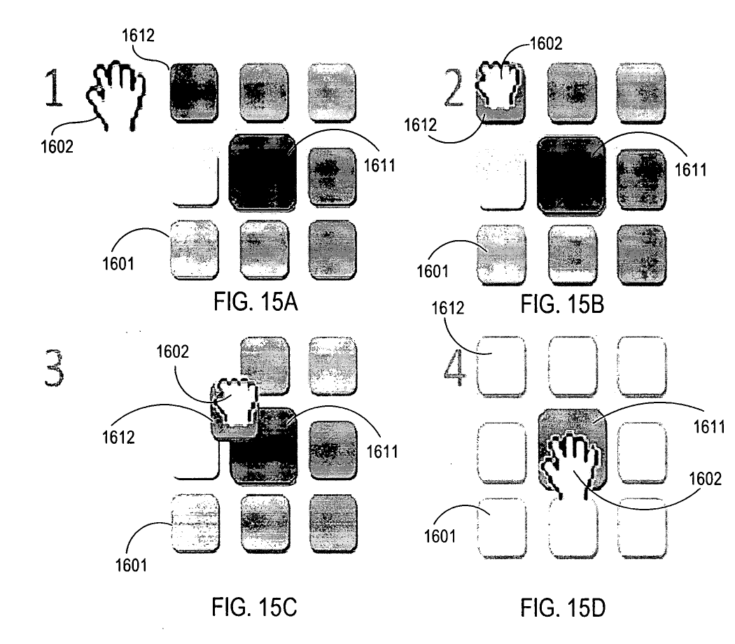

FIGS. 15A, 15B, 15C, and 15D depict such an embodiment. Grid 1601 and mouse cursor 1602 are displayed within each of FIGS. 15A-15D. Grid 1601 displays level 1 of a vertical information hierarchy; the detail content of the nodes is not depicted. Grid 1601 includes center cell 1611 and peripheral cell 1612.

FIG. 15B shows cursor 1602 moved over peripheral cell 1612, which is dragged by mouse cursor 1602 over center cell 1611 as shown in FIG. 15C. In FIG. 15D, peripheral cell 1612 is dropped in center cell 1611, specifying selection of the peripheral cell 1612 for expansion within grid 1601. In response, the content of the particular node that was displayed in peripheral cell 1612 is now displayed in center cell 1611. Nodes in the second level of the vertical hierarchy that are children of the particular node are now displayed in peripheral cells.

Any type of collection of information nodes may be displayed within grid 1601, including, but not limited to, a vertical hierarchy, flat hierarchy, or bi-coordinate hierarchy. Further, grid 1601 need part of hierarchical grid hierarchy in which multiple levels of the grid hierarchy are displayed.

### Penta-Grid

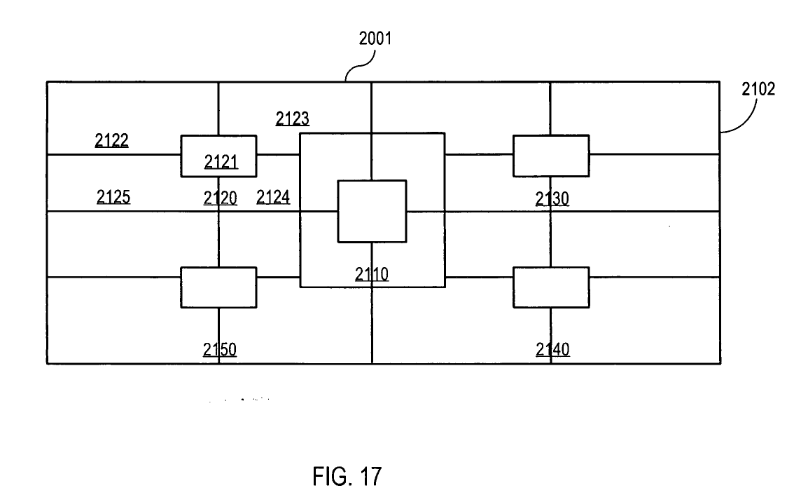

As explained earlier, an embodiment of the present invention is not limited to any particular fractal pattern, in particular, nine cell patterns. FIG. 17 shows a fractal grid hierarchy based on a penta-grid pattern in which a cell is divided into quadrants and a center cell is placed and overlaps the intersection of the quadrants.

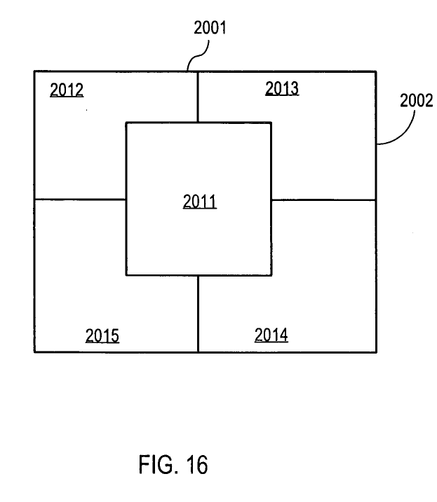

FIGS. 16 and 17 depict a display of a fractal grid hierarchy 2001, a user interface used for displaying information organized as a fractal grid hierarchy. Fractal grid hierarchy 2001 includes a penta-grid controls 2002 (FIG. 16) and 2102 (FIG. 17). Displayed within grid control 2002 are five cell controls 2011, 2012, 2013, 2014, and 2015. Each of these cells is demarcated by a border and may have a different color. This display of the fractal grid hierarchy corresponds to level 1 of the fractal grid hierarchy. Accordingly, cell 2011 is a main center cell and cells 2012-2015 are peripheral main cells. Each of the peripheral cells occupies a position with respect to the center cell. Cell 2012 is in the top-left position, cell 2013 the top-right, cell 2014 right-bottom and cell 2015 bottom-left.

Fractal penta-grid control 2102 represents fractal grid hierarchy 2001 at the second level. Like level 1, a penta-grid with five main cell controls is displayed. However, each main cell is further divided into five base cells according to the penta-grid pattern.

Penta-grid control 2102 consists of five main cells 2110, 2120, 2130, 2140, and 2150. Each of these main cells is a grid cell consisting of five cells.

For example, cell 2120 comprises cell controls 2121, 2122, 2123, 2124, and 2125.

### Implementation Mechanisms

An embodiment of invention may be implemented, at least in part, using many types of computer systems that include a graphical display, including a personal computer and monitor and handheld computer or smart phone with an integrated display device. A fractal grid interface may be implemented using executable programs that reside on the computer. The programs, when executed, read data representing a collection of information nodes from, for example, volatile memory date structures, a file, database, Web server on the internet, and/or combination thereof. The implementation of the fractal grid hierarchy is not limited to any particular computer and/or software architecture. A collection of information nodes is not limited to any data structure or any type of source of data.

Furthermore, an embodiment of the present invention is not limited to any particular electronic machine or system. In addition to being implemented on general purpose computer, computer systems, or portable computers, an embodiment of the present invention may be implemented on any type of machine or system capable of generating a graphical user interface on video display. For example, a television or video monitor coupled to a satellite receiver, cable top box, or digital video recorded may cooperate to provide a fractal grid interface. In fact, the television itself may contain hardware and/or software needed generate the interface.

Nor is an embodiment of the present invention limited to displaying any particular type of information. The information displayed can be, without limitation, television listings, catalogue listings, and any form of advertising.

A collection of information nodes displayed as a fractal grid hierarchy can be generated by input entered via the fractal grid interface. For example, a fractal grid interface may be used to create and/or modify a vertical information hierarchy. Referring to FIG. 2, a user may enter input for the content for the root node via dialogue box 6. The user may then manipulate the slider controls to position 1 to display the next the level of the fractal grid hierarchy and enter content for level 1 nodes of the vertical information hierarchy. To enter such content, a user clicks on peripheral cell, invoking a dialogue box or user graphical control or graphical user interface that may be used to enter content for a level 1 node.

In an embodiment, the fractal grid interface may be generated by a browser executing code downloaded over the Internet from a Web server, such as Java code.

Finally, an information node may be described herein as being displayed when in fact the information node may not have any content and there may be no specific data structure that exists for the information node. Thus, stating that an information node is being displayed within a cell does not necessarily imply that the information node has content or that a data structure for it exists.

### Computer Hardware Overview

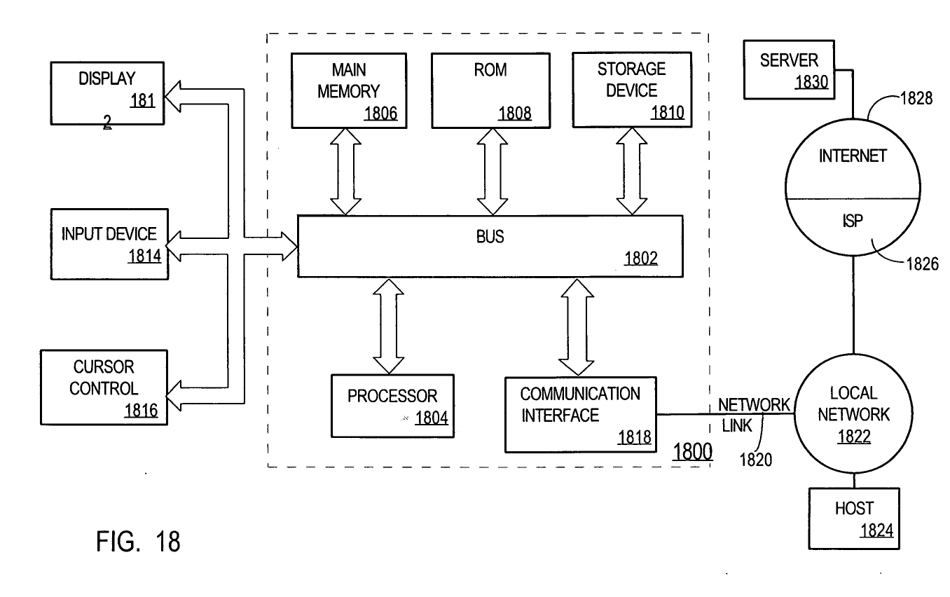

FIG. 18 is a block diagram that illustrates a computer system 1800 upon which an embodiment of the invention may be implemented. Computer system 1800 includes a bus 1802 or other communication mechanism for communicating information, and a processor 1804 coupled with bus 1802 for processing information. Computer system 1800 also includes a main memory 1806, such as a random access memory (RAM) or other dynamic storage device, coupled to bus 1802 for storing information and instructions to be executed by processor 1804. Main memory 1806 also may be used for storing temporary variables or other intermediate information during execution of instructions to be executed by processor 1804. Computer system 1800 further includes a read only memory (ROM) 1808 or other static storage device coupled to bus 1802 for storing static information and instructions for processor 1804. A storage device 1810, such as a magnetic disk or optical disk, is provided and coupled to bus 1802 for storing information and instructions.

Computer system 1800 may be coupled via bus 1802 to a display 1812, such as a cathode ray tube (CRT), for displaying information to a computer user. An input device 1814, including alphanumeric and other keys, is coupled to bus 1802 for communicating information and command selections to processor 1804. Another type of user input device is cursor control 1818, such as a mouse, a trackball, or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane.

The invention is related to the use of computer system 1800 for implementing the techniques described herein. According to one embodiment of the invention, those techniques are performed by computer system 1800 in response to processor 1804 executing one or more sequences of one or more instructions contained in main memory 1806. Such instructions may be read into main memory 1806 from another machine-readable medium, such as storage device 1810. Execution of the sequences of instructions contained in main memory 1806 causes processor 1804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 1800, various machine-readable media are involved, for example, in providing instructions to processor 1804 for execution. Such a medium may take many forms, including but not limited to storage media and transmission media. Storage media includes both non-volatile media and volatile media. Non-volatile media includes, for example, optical or magnetic disks, such as storage device 1810. Volatile media includes dynamic memory, such as main memory 1806. Transmission media includes coaxial cables, copper wire and fiber optics, including the wires that comprise bus 1802. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1804 for execution. For example, the instructions may initially be carried on a magnetic disk of a remote computer. The remote computer can load the instructions into its dynamic memory and send the instructions over a telephone line using a modem. A modem local to computer system 1800 can receive the data on the telephone line and use an infra-red transmitter to convert the data to an infra-red signal. An infra-red detector can receive the data carried in the infra-red signal and appropriate circuitry can place the data on bus 1802. Bus 1802 carries the data to main memory 1806, from which processor 1804 retrieves and executes the instructions. The instructions received by main memory 1806 may optionally be stored on storage device 1810 either before or after execution by processor 1804.

Computer system 1800 also includes a communication interface 1818 coupled to bus 1802. Communication interface 1818 provides a two-way data communication coupling to a network link 1820 that is connected to a local network 1822. For example, communication interface 1818 may be an integrated services digital network (ISDN) card or a modem to provide a data communication connection to a corresponding type of telephone line. As another example, communication interface 1818 may be a local area network (LAN) card to provide a data communication connection to a compatible LAN. Wireless links may also be implemented. In any such implementation, communication interface 1818 sends and receives electrical, electromagnetic or optical signals that carry digital data streams representing various types of information.

Network link 1820 typically provides data communication through one or more networks to other data devices. For example, network link 1820 may provide a connection through local network 1822 to a host computer 1824 or to data equipment operated by an Internet Service Provider (ISP) 1826. ISP 1826 in turn provides data communication services through the world wide packet data communication network now commonly referred to as the “Internet” 1828. Local network 1822 and Internet 1828 both use electrical, electromagnetic or optical signals that carry digital data streams. The signals through the various networks and the signals on network link 1820 and through communication interface 1818, which carry the digital data to and from computer system 1800, are exemplary forms of carrier waves transporting the information.

Computer system 1800 can send messages and receive data, including program code, through the network(s), network link 1820 and communication interface 1818. In the Internet example, a server 1830 might transmit a requested code for an application program through Internet 1828, ISP 1826, local network 1822 and communication interface 1818.

The received code may be executed by processor 1804 as it is received, and/or stored in storage device 1810, or other non-volatile storage for later execution. In this manner, computer system 1800 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method for displaying a collection of information nodes organized as a fractal grid hierarchy, comprising
displaying a first subset of said collection of information nodes, wherein each information node of said first subset is displayed within a first cell control within a first grid control that comprises nine first cell controls;
receiving an input that indicates to display another level of the fractal grid hierarchy; and
in response to receiving said input:
displaying second nine cell controls within a second grid control, said second nine cell controls including a main center cell control and eight main peripheral cell controls;
wherein each of said main center cell control and eight main peripheral cell controls include nine base cell controls;
wherein each information node of said first subset is displayed in a base cell control within said main center cell control;
wherein other information nodes of said collection are displayed in said main peripheral cell controls; and
wherein each other information node of said other information nodes is displayed within a base cell of said main peripheral cell.

2. The computer-implemented method of claim 1,
wherein said collection of information nodes is a vertical information hierarchy of information nodes;
wherein said vertical information hierarchy includes a root node, level one nodes that are children of the root node, and level two nodes that are children of the level one nodes;
wherein said root node is displayed within a center cell of said first grid control and a center base cell of said main center cell control of said second grid control;
wherein said each level one node of said level one nodes is displayed:
within a peripheral cell of said first grid;
within a base peripheral cell of said main center cell control of said second grid control;
within a base center cell of a main peripheral cell of said second grid control;
wherein for each main peripheral cell of said second grid control, a child node of the level one node is displayed within the base center cell of the said each main peripheral cell.

3. The computer-implemented method of claim 1,
wherein the collection of information nodes is a flat hierarchy that includes a root node and child nodes of said root node;
wherein said flat hierarchy includes a first set of eight first nodes of said child nodes and other sets of nodes of said child nodes;
wherein said root node is displayed within a center cell of said first grid control and a center base center cell of said main center cell control of second grid control;
wherein each first node of said first set of eight first nodes is displayed:
within peripheral cell of said first grid control; and
within a base peripheral cell of said main center cell control of said second grid control;
wherein each set of other sets of nodes is expanded in main peripheral cell of said second grid.

4. The computer-implemented method of claim 3, wherein said root node represents query text submitted to a search engine and each of child node of said child nodes represents a result returned by said search engine for said query text.

5. The computer-implemented method of claim 2, wherein the steps further include displaying content of a root node of said collection of nodes within a single cell control that is not displayed as being part of any multi-cell grid control.

6. The computer-implemented method of claim 1, wherein the steps further include manipulating a certain cell control in either said first grid or said second grid to display more detail of an information node displayed by said certain cell control.

7. The computer-implemented method of claim 6, to display more detail includes to display a Web page associated with link displayed within said certain cell.

8. The computer-implemented method of claim 1, wherein manipulation of user graphical control causes receiving of said input.

9. The computer-implemented method of claim 8, wherein said user graphical control is a slider with positions that each correspond to a level of said fractal grid hierarchy.

10. The computer-implemented method of claim 1, wherein:
each node in the first subset is associated with a subarea based on two coordinates;
each of the cell of the first grid control is associated with a subarea based on the two coordinates; and
wherein displaying a first subset of said collection of information nodes includes displaying each node in the first subset in a cell associated with the subarea that is associated with said each node.

11. The method of claim 10, wherein:
each node displayed within the second control is associated with a subarea based on the two coordinates;
wherein each cell in said second grid control is associated with a subarea based on the two coordinates; and
wherein each node displayed in the second grid control is displayed within a cell associated with the subarea that is associated with said each node displayed in the second grid control.

12. The method of claim 1, wherein the step of displaying a first subset of said collection of information nodes is performed in response to dragging and dropping a certain control onto said first grid control, said certain control representing said collection of information nodes.

13. The method of claim 1, wherein the step of displaying a first subset of said collection of information nodes is performed in response to moving a cursor over a certain control, said certain control representing said collection of information nodes.

14. The method of claim 12, wherein the second control is displayed in response to manipulating a cell on the first grid control.

15. A computer-implemented method for displaying a collection of information nodes, said collection of information nodes comprising levels that each contains a subset of said collection of nodes, the computer-implemented method comprising:
displaying a first subset of nodes from a first level of said collection of information nodes, wherein each node of said first subset is displayed within a first cell control within a grid control that comprises nine cell controls, including eight peripheral cells and a center cell;
receiving an input that indicates a selection of a particular peripheral cell, wherein the particular peripheral cell is associated with a particular node, wherein the particular node is associated with a second subset of nodes in a second level of the collection of nodes; and
in response to receiving said input, expanding the particular node displayed within said particular peripheral cell within the grid control, wherein expanding the node includes:
displaying the particular node in the center cell, and
displaying each node of said second subset of nodes in a certain peripheral cell of the grid control.

16. The computer-implemented method of 15, wherein said first input is caused by a drag and drop operation involving dragging the certain peripheral to the center cell.

17. A computer-implemented method for displaying a collection of information nodes organized as a fractal grid hierarchy, comprising
displaying a first subset of a collection of information nodes, wherein each information node of said first subset is displayed within a first cell control within a first grid control that comprises first cell controls that together are displayed in conformity to a pattern within the first grid control;
receiving an input that indicates to display a second level of the fractal grid hierarchy;
in response to receiving said input, displaying second cell controls within a second grid control, said second grid control comprising second main cell controls for each first cell control of said first cell controls and together conforming to the pattern;
wherein within each second cell control of said second cell controls, displaying base cell controls that together are displayed in conformity with the pattern within said each second cell control;
wherein for each particular node displayed within a peripheral first cell control of said first cell controls, displaying said each particular node in a base cell control within a peripheral second main cell control of said second grid control; and
wherein other information nodes of said collection are displayed in a peripheral base cell control of a peripheral second main control of said second grid.

18. The computer-implemented method of claim 17,
wherein said collection of information nodes is a vertical information hierarchy of information nodes;
wherein said vertical information hierarchy includes a root node, level one nodes that are children of the root node, and level two nodes that are children of the level one nodes;
wherein said root node is displayed within a center cell of said first grid control and a center base cell of a main center cell control of said second grid control;
wherein said each level one node of said level one nodes is displayed:
within a peripheral cell of said first grid;
within a base peripheral cell of said main center cell control of said second grid control;
within a base center cell of a main peripheral cell of said second grid control; and
wherein for each main peripheral cell of said second grid control, a child node of the level one node is displayed within the base center cell of the said each main peripheral cell.

19. The computer-implemented method of claim 17,
wherein the collection of information nodes is a flat hierarchy that includes a root node and child nodes of said root node;
wherein the pattern includes N number of cells and a center cell;
wherein said flat hierarchy includes a first set of N first nodes of said child nodes and other sets of nodes of said child nodes;
wherein said root node is displayed within a center cell of said first grid control and a center base center cell of said main center cell control of second grid control;
wherein each first node of said first set of N first nodes is displayed:
within peripheral cell of said first grid control; and
within a base peripheral cell of said main center cell control of said second grid control; and
wherein each set of other sets of nodes is expanded in main peripheral cell of said second grid.

20. The computer-implemented method of claim 19, wherein said root node represents query text submitted to a search engine and each of child node of said child nodes represents a result returned by said search engine for said query text.

21. The computer-implemented method of claim 18, wherein the steps further include displaying content of a root node of said collection of nodes within a single cell control that is not displayed as being part of any multi-cell grid control.

22. The computer-implemented method of claim 17, wherein the steps further include manipulating a certain cell control in either said first grid or said second grid to display more detail of an information node displayed by said certain cell control.

23. The computer-implemented method of claim 22, to display more detail includes to display a Web page associated with link displayed within said certain cell.

24. The computer-implemented method of claim 17, wherein manipulation of user graphical control causes receiving of said input.

25. The computer-implemented method of claim 24, wherein said user graphical control is a slider with positions that each correspond to a level of said fractal grid hierarchy.

26. The computer-implemented method of claim 17, wherein the pattern comprises five or nine cells.
